(19) United States
(12) Patent Application Publication
(10) Pub. No.: US 2006/0257559 A1
(43) Pub. Date: Nov. 16, 2006

(54) METHOD AND SYSTEM FOR INSITU REPAIR OF INTERIOR WATER PIPES

(76) Inventor: Danny R. Warren, (US)

Correspondence Address: BARLOW, JOSEPHS & HOLMES, LTD., 101 DYER STREET, 5TH FLOOR, PROVIDENCE, RI, 02903, US

(21) Appl. No.: 11/382,145

(22) Filed: May 8, 2006

Related U.S. Application Data
(60) Provisional application No. 60/679,786, filed on May 11, 2005.

(51) Int. Cl. B05D 7/22

(52) U.S. Cl. 427/230

(57) ABSTRACT

A method and system for cleaning and coating the interior surface of a small diameter piping system is provided. The method provides for cleaning the interior surfaces of the piping system to remove the scale or corrosion build-up therein and the application of a coating to prevent ongoing reaction between the material being conducted and the interior walls of the piping system. The method provides for removing the fixtures from all of the piping termination points, cleaning the piping and coating the interior surfaces of the piping with a non-toxic resin.

### CROSS-REFERENCE TO RELATED APPLICATIONS

This application is related to and claims priority from earlier filed U.S. Provisional Patent Application No. 60/679,786, filed May 11, 2005, the contents of which are incorporated herein by reference.

### BACKGROUND OF THE INVENTION

The present invention relates generally to a method and system for repairing piping systems in their installed location. More specifically, the present invention is directed to a method and system for cleaning and coating the interior surfaces of installed piping in its installed location in order to remove buildup therein and to encapsulate oxidation or scale thereby preventing it from reforming.

It is well known that all types of piping systems, such as water pipes, gas pipes, sewer pipes, and the like, are susceptible to the build up of deposits or scale along their inner surfaces. One of the reasons for such build-up is corrosion or rusting of the interior pipe surface. Another reason that results in the build-up of scale is the deposit of minerals, such as lime or other solids typically found in hard water, as the water flows through the interior of the pipe. These deposits can lead to a narrowing of the interior diameter of the pipe, which in turn can reduce the throughput, cause the formation of pits, and ultimately jeopardize the pipe integrity thereby leading to premature failure of the pipe system.

This is particularly problematic in water distribution systems, because in many parts of the country, water distribution piping systems within buildings were fabricated from galvanized or lined steel piping. Over time, the chemical composition of drinking water passing through these metallic pipes causes corrosion and/or a scale formation on the interior walls of the distribution pipe system.

Further, the hardness of the water being conducted through these pipes varies widely from soft to hard relative to the geographical region where the water source originates. Water that contains little or no magnesium and/or calcium is considered soft and typically attacks the interior surface of the pipes resulting in metal-dissolution and the release of debris into the flow of water over the entire wetted surface. This debris is then carried through the pipes to the eventual user of the water. With medium water, there is often an interaction between corrosion and the formation of a protective layer. As a result, blister-like pockets of corrosion form along the wetted portions of the pipe. These pockets in turn lead to the subsurface formation of rust that may then be conveyed by the water flow and precipitate on bare metal surfaces, or may ultimately be discharged to the consumer. When distributing hard water containing high levels of magnesium, calcium and/or iron through the pipe system, a buildup of scale deposits will occur, wherein an increase in water temperature serves to accelerate the precipitation of these minerals. These scale formations or deposits grow continuously and ultimately result in the clogging of the pipes. Further, due to the accelerated buildup of minerals at higher temperatures, hot water distribution systems become particularly vulnerable wherein the water heater and hot water pipes quickly become corroded and clogged.

In many cases it is difficult if not impossible to service residential and commercial piping systems that are installed within a building. The difficulty that arises is that large portions of these piping systems are installed during the construction of the building and are therefore not accessible for repair. Since the piping used in these applications are relatively small in diameter many methods utilized in large pipe applications are simply not workable. Accordingly, in most residential or industrial buildings, the only prior art solution available was to disassemble and reroute the water distribution piping system in a process that would entail a large amount of labor and expense while also causing an extreme inconvenience to the tenants being serviced by this system.

Accordingly, there is a need for a method and system of renovating small diameter piping systems in their installed locations. There is a further need for a method and system of cleaning and coating the interior surfaces of a small diameter piping system without requiring that the system be fully disassembled. There is still a further need for a method and system of cleaning and coating the interior walls of a small diameter piping system in a manner that does not impede the flow of material therethorugh after the renovation process is completed.

### BRIEF SUMMARY OF THE INVENTION

In this regard, the present invention provides for a method and system for cleaning and coating the interior surface of a small diameter piping system that can be accomplished with a minimum amount of disassembly and disruption of service. More particularly, the method and system of the present invention is particularly tailored for used in connection with small diameter water distribution piping, whereby the interior surfaces of water distribution pipes are cleaned to remove the scale or corrosion build-up therein and a coating is installed to prevent ongoing reaction between the water being conducted and the interior walls of the piping system. The present invention is particularly advantageous because it allows the entire piping system to be cleaned and coated with the piping remaining in its installed position.

As will be described in more detail below, the method provides for removing the fixtures from all of the piping termination points. The system is then cleaned by circulating abrasive slurry through the piping. Once the interior surfaces of the piping are cleaned, the abrasive slurry is flushed out and the interior surfaces of the piping are coated with a non-toxic resin. The resin coating, once cured, provides an impervious barrier on the interior of the pipe that prevents further deterioration and buildup on the interior surfaces of the pipe.

It is therefore an object of the present invention to provide a method and system for the cleaning and coating of the interior surfaces of a small diameter piping system. It is a further object of the present invention to provide a method and system for cleaning and coating the interior surfaces of a piping system wherein a non-toxic food grade resin is employed to coat the interior surfaces of the piping. It is yet a further object of the present invention to provide a system and method of cleaning and coating the interior surfaces of a small diameter piping system that can be implemented with minimal system disruption and disassembly requirements.

These together with other objects of the invention, along with various features of novelty, which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a representational view of a small diameter piping system in the context of a residential dwelling;

FIG. 1a is a cross-sectional view of the piping system taken along line 1a-1a of FIG. 1;

FIG. 2 is an illustration showing the pippins system being cleaned in accordance with the method of the present invention;

FIG. 2a is a cross-sectional view of the piping system taken along line 2a-2a of FIG. 2 after the piping has been cleaned;

FIG. 3 is an illustration showing the piping system being filled with epoxy resin in accordance with the method of the present invention;

FIG. 3a is a cross-sectional view of the piping system taken along line 3a-3a of FIG. 3 showing the piping system filled with epoxy resin;

FIG. 4 is an illustration showing the excess resin being drained from the piping system in accordance with the method of the present invention; and

FIG. 4a is a cross-sectional view of the piping system taken along line 4a-4a of FIG. 4 after the piping has been coated in accordance with the method of the present invention.

### DETAILED DESCRIPTION OF THE INVENTION

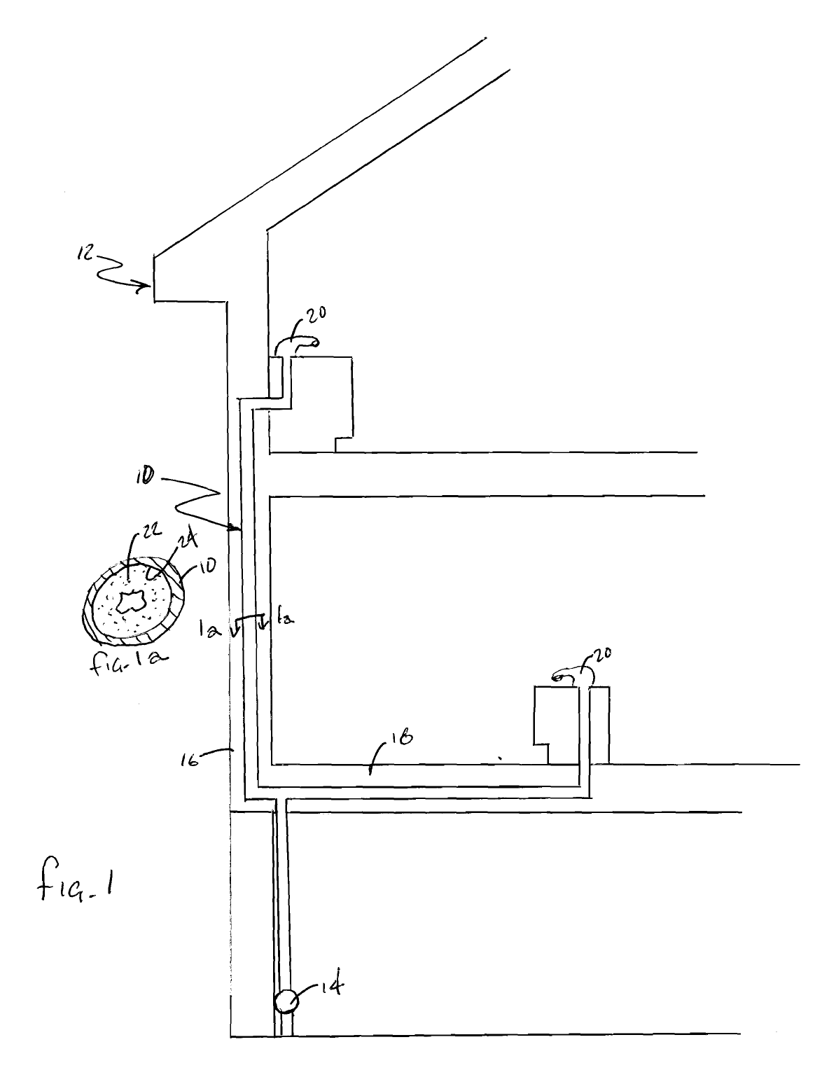

Now referring to the drawings, various steps of the method of the present invention are shown and generally illustrated in FIGS. 1-4. It is important to understand that while this preferred embodiment is shown for the purpose of illustration, the system and method of the present invention may be accomplished by using many different structural variations that are still intended to be covered within the scope of the present invention.

Turning now to FIG. 1, a small diameter piping system 10 is shown in the form of a water distribution pipe in the context of a residential dwelling 12. The piping system 10 can be seen to enter the residential dwelling 12 in the basement at a water meter 14. The piping system 10 then extends into the walls 16 and floors 18 of the residential dwelling 12 to deliver water to the various fixtures 20 throughout the dwelling 12. These fixtures 20 may include, but are not limited to sinks, showers, toilets, outdoor faucets, water heaters, etc. It should be further appreciated that since the distribution piping 10 servicing these fixtures 20 is installed within the structure of the dwelling 12, i.e. behind the wallboard or beneath the flooring, the piping 10 is not generally accessible for service or repair. As was stated above, depending on the condition of the water being carried within the pipes 10, over time corrosion or scale 22 as is illustrated in FIG. 1a may build up on the interior walls 24 of these pipes 10 thereby restricting or blocking flow. The method of the present invention is directed to the removal of this scale 22 and the coating of the interior 24 of the pipe 10 without necessitating removal and replacement of the piping 10.

It should be further appreciated that while the method of the present invention is being illustrated in the context of a residential water distribution system, this context is being used for illustration purposes only. The method of the present invention is intended to be enabled for use in connection with any small diameter piping system 10 that is prone to flow restriction due to the deterioration of the interior surfaces 24 of the piping 10 itself. The method of the present invention is equally useful in the residential, commercial or industrial setting and may be implement in water distribution systems, sanitary sewers, drains, fuel distribution lines, and any other process piping wherein such a renovation method is indicated.

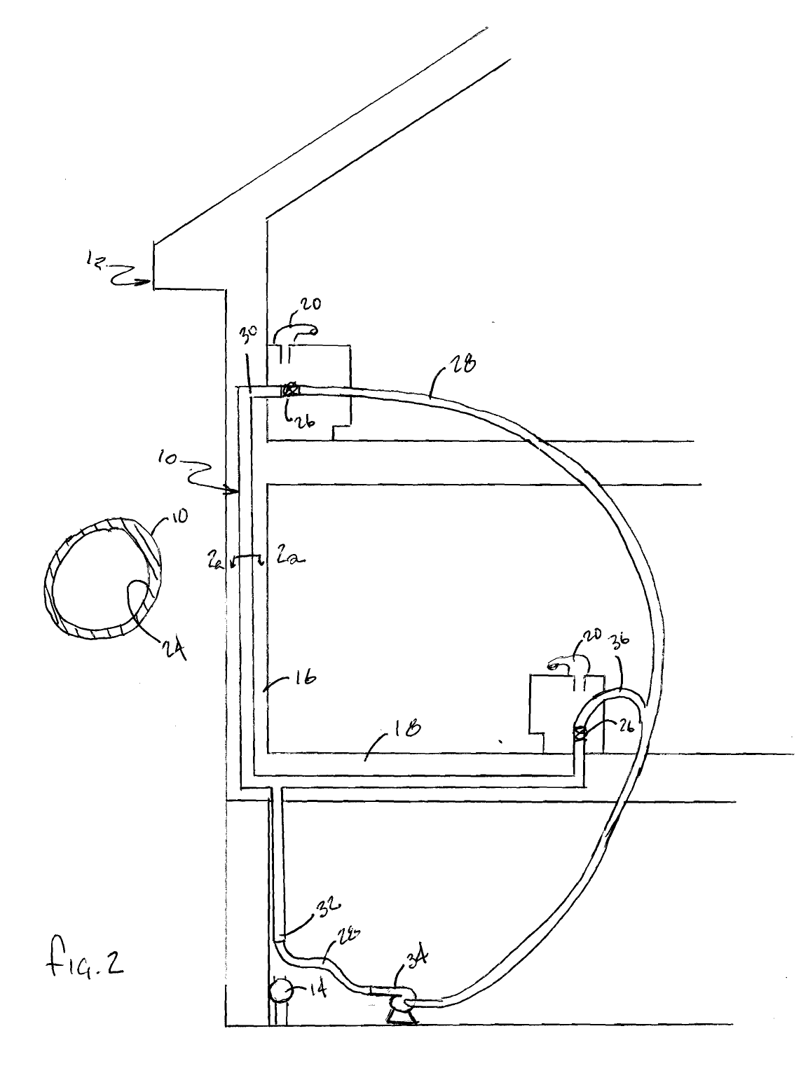

Turning now to FIG. 2, the initial steps of the method of the present invention are shown as being implemented. In this regard the method of the present invention provides for initially removing all of the terminal fixtures 20 from the remote ends of the piping system 10 throughout the house 12. This can be accomplished by actual removal of the fixture 20 or by simply disconnecting the fixture 20 from the piping system 10. This allows access to the piping system 10 for the remaining steps of the method of the present invention while also preventing the coating material that will be introduced into the system 10 from interfering with the various valves and control devices that ate located within the terminal fixtures 20. Once the terminal fixtures 20 have been disconnected, control valves 26 may be installed on the piping system 10 at each fixture 20 location thereby providing the ability to maintain the piping system 10 as a closed loop system for the cleaning and coating steps. Further, by installing control valves 26, the piping system 10 can be addressed on a branch by branch basis by simply closing the control valve 10 and preventing flow along the idle branch until it is desired.

Once the fixtures 20 have been removed, a hose 28 is connected to the high point 30 and low point 32 of the system. Additionally, a pump 34 is installed in line with the piping system 10 and hose 28 to form a closed loop. It is also possible that the loop may include more than one branch 36 as is depicted in FIG. 2. The piping system 10 is then filled with a slurry of abrasive aggregate wherein the pump 34 circulates the slurry throughout the entire piping system 10 to clean the interior surfaces 24 of the pipes 10 thereby removing any corrosion and or scale 22 from the interior walls 24 of the piping system 10. Further, the abrasive slurry serves to rough up the interior walls 24 creating a desirable bonding surface for the installation of the resin coating. Typically, this step must be performed with a slurry pump or a trash pump, as light duty pumps cannot handle the circulation of abrasive slurry.

Once the interior surfaces of the piping system 10 have been cleaned, the circulating hoses 28, 36 are removed and the slurry is drained and purged from the piping system 10 leaving the interior of the piping system 10 clean and free of scale 22 as is shown in the cross-section of FIG. 2a. This may also be accomplished by flushing the piping system 10 with clean water until all of the residual slurry has been purged from the piping system 10.

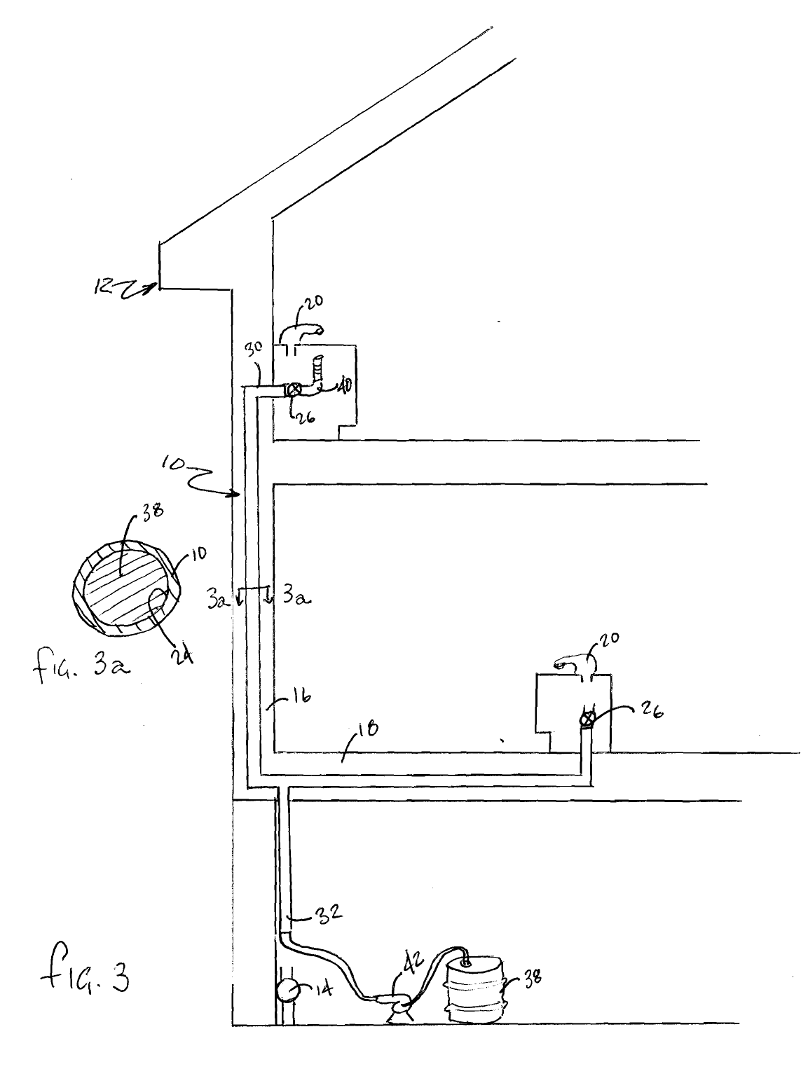

Turning now to FIG. 3, the piping system 10 is prepared for filling with the epoxy resin material 38. In this manner, an inspection device such as a sight glass 40 or any other suitable inspection port is installed at the highest point 30 in the piping system 10. It is also preferable that this high point 30 in the system remain open to the atmosphere to allow air to escape from the piping system 10 as it is filled with the epoxy resin material 38. The epoxy coating material 38 is then introduced into the piping system 10 using a pump 42 and pumping the epoxy resin 38 into the piping system 10 at the lowest point 32 within the system 10. As the piping system 10 is being filled with the epoxy resin 38, each of the control valves 26 that were installed is opened in turn in order to bleed off any trapped air from within the various branches in the piping system 10. Once the epoxy resin 38 reaches the end of the branch, the valve 26 is again closed. The filling is continued until epoxy 38 reaches the inspection device 40 at the highest point 30 in the piping system 10. For a normal sized house, approximately 2-3 gallons of epoxy 38 is required for filling the piping system 10. Further, the preferred epoxy resin 38 is non-toxic. For example, S301 Epoxy resin is preferred. FIG. 3a depicts a cross-section of the piping 10 filled with the epoxy resin 38.

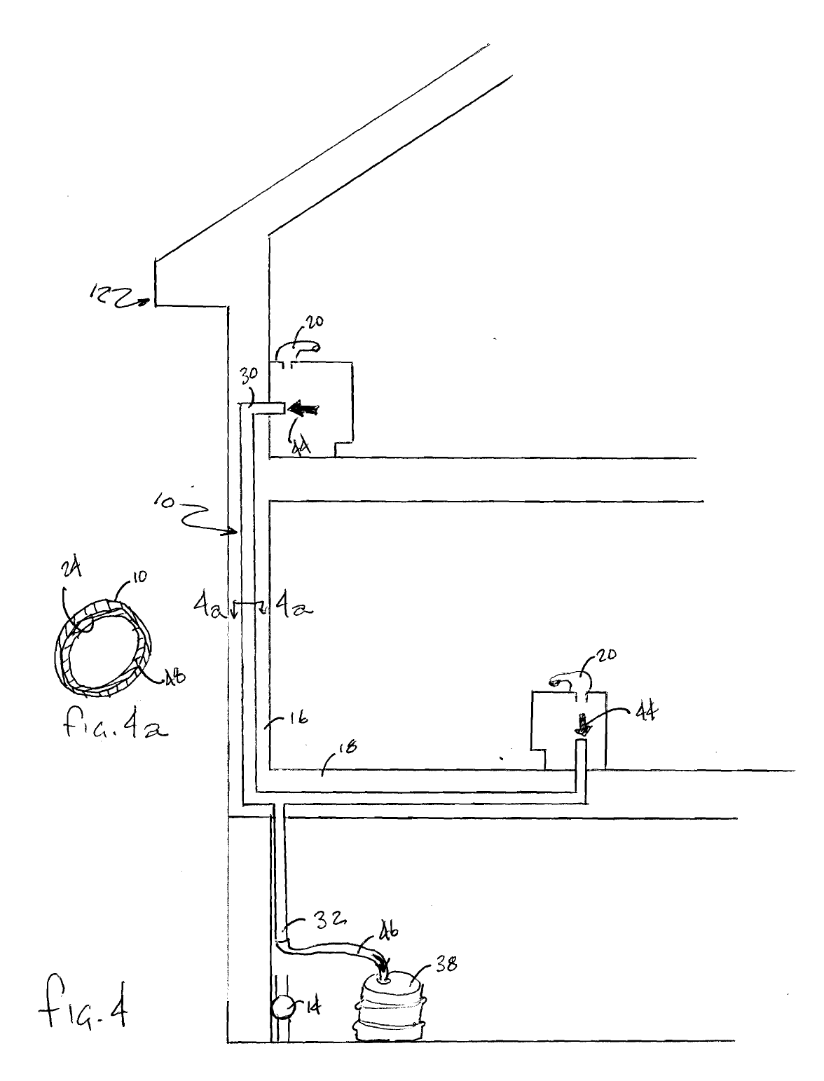

Turning now to FIG. 4, once the inspection device 40 at the highest point 30 of the piping system 10 is filled with epoxy 38, the inspection device 40 is removed and an air compressor is attached to the piping system 10 at the highest point 30. The compressor is used to charge the entire piping system 10 with a small low-pressure charge of air 44. The preferred charge of air 44 is in the range of 1-2 psi. This air pressure 44 is important in that it creates downward pressure on the epoxy 38 within the piping system 10 that in turn urges the epoxy material 38 in the piping system 10 in a downward direction. In this manner, a drain line 46 is directed into a waste bin to collect the excess epoxy resin 38 as it is drained out of the piping system 10 into a collection bin. Further, the compressor can in turn be attached to each of the branches in the piping system 10 to urge the excess epoxy out of each branch.

It is in this step that the nature of the epoxy coating 38 can be seen as critical. First, the epoxy 38 must be formulated to have a known sag value. In this disclosure it is preferable that the epoxy 38 be capable of holding a coating build of approximately 3/16″ to ⅛″ without sagging. In this manner as the low-pressure air 44 is utilized to urge the excess epoxy 38 out of the system, while a predictable coating having a known thickness will remain adhered to the interior walls 24 of the piping system 10. Should a high-pressure charge of air be utilized, as is often the case in the prior art, the rush of air would scour the interior surfaces 24 of the pipe 10 removing much of the epoxy coating 38 from the interior surfaces 24 of the piping system 10. The result would be an uneven and often too thin coating residue that would be subject to failure. Instead, the low pressure air 44 allows a highly even and predictable coating thickness 48 to remain adhered to the interior surfaces 24 of the piping system 10 as is depicted in the cross-sectional view of FIG. 4a.

With the coating process completed, the fixtures 20 are then replaced and the system 10 can be reactivated and is ready for normal operation.

It can therefore be seen that the present invention provides a novel method whereby the interior surfaces of a small diameter piping system can be cleaned of corrosion and scale buildup and subsequently coated with epoxy. The method of the present invention provides for this operation while the piping system remains in its installed position without the need for complete disassembly and replacement of the existing pipes with new pipes. This, of course, avoids the cost associated with re-fitting the entire house with new pipes. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method for cleaning and coating interior surface walls of a small diameter pipe system comprising the steps of:
disconnecting all terminal fixtures from the piping system;
circulating abrasive slurry through the piping system to clean the interior surface walls of the piping system;
purging the abrasive slurry from the piping system;
filling said piping system with an epoxy resin;
applying low pressure air to a high point of said system;
draining any epoxy resin from said piping system that has not adhered to the interior surface walls of said piping system, wherein said low pressure air urges excess epoxy from the interior of said piping system; and
reconnecting all of said terminal fixtures.

2. The method of claim 1, wherein said epoxy is a non-toxic epoxy.

3. The method of claim 1, further comprising the step of:
installing valves at each location where a terminal fixture was disconnected.

4. The method of claim 3, wherein said step of circulating abrasive slurry further comprises circulating said abrasive slurry by creating a closed loop between a low point in said piping system and each of said valves.

5. The method of claim 3, said step of filling said piping system with an epoxy resin further comprising:
opening said valves to purge trapped air from said piping system, thereby allowing said piping system to be fully filled with said epoxy resin.

6. The method of claim 3, further comprising the step of:
installing an inspection device at a high point in said piping system.

7. The method of claim 1, wherein said low-pressure air is at a pressure of between approximately 1-2 psi.

8. The method of claim 1, wherein said epoxy is low sag epoxy material.

9. The method of claim 8, wherein said low sag epoxy will built to a layer of approximately between ⅛″ and 3/16″ without sagging.

10. A method for cleaning and coating interior surface walls of a small diameter pipe system comprising the steps of:
disconnecting all terminal fixtures from the piping system;
identifying a high point and a low point in said piping system;
circulating abrasive slurry through the piping system to clean the interior surface walls of the piping system;
purging the abrasive slurry from the piping system;
installing an inspection device at said high point in said piping system;
filling said piping system with an epoxy resin until said resin is visible in said inspection device;
applying low pressure air to said high point of said system;
draining any epoxy resin from said piping system that has not adhered to the interior surface walls of said piping system, wherein said low pressure air urges excess epoxy from the interior of said piping system; and
reconnecting all of said terminal fixtures.

11. The method of claim 10 wherein said epoxy is a non-toxic epoxy.

12. The method of claim 10. further comprising the step of:
installing valves at each location where a terminal fixture was disconnected.

13. The method of claim 12, wherein said step of circulating abrasive slurry further comprises circulating said abrasive slurry by creating a closed loop between a low point in said piping system and each of said valves.

14. The method of claim 12, said step of filling said piping system with an epoxy resin further comprising:
opening said valves to purge trapped air from said piping system, thereby allowing said piping system to be fully filled with said epoxy resin.

15. The method of claim 10 wherein said low-pressure air is at a pressure of between approximately 1-2 psi.

16. The method of claim 10, wherein said epoxy is low sag epoxy material.

17. The method of claim 16, wherein said low sag epoxy will built to a layer of approximately between ⅛″ and 3/16″ without sagging.
